(19) United States
(12) Patent Application Publication
(10) Pub. No.: US 2024/0124754 A1
(43) Pub. Date: Apr. 18, 2024

(54) Methods and Compositions for Adhering to Low Surface Energy Materials

(71) Applicant: Zephyros, Inc., Romeo, MI (US)

(72) Inventors: Vincent Duclos, Molsheim Cedex (FR); Michael Czaplicki, Romeo, MI (US)

(21) Appl. No.: 17/769,155

(22) PCT Filed: Nov. 15, 2019
(86) PCT No.: PCT/US2019/061696

§ 371 Date: Apr. 14, 2022

(51) Int. Cl. C09J 163/00; C09J 11/04; C09J 11/08

(52) U.S. Cl. CPC C09J 163/00; C09J 11/04; C09J 11/08

(57) ABSTRACT

A two-part adhesive composition for the bonding of a low surface energy polymer to a substrate material, the adhesive comprising: a part A including one or more of an epoxy having at least two epoxy groups per molecule or a reaction product of an epoxy and a thiol, phenolic or carboxylic acid-functional species; and a part B comprising a reaction product of an epoxy and a thiol, phenolic or carboxylic acid-functional species, wherein the thiol, phenolic or carboxylic acid-functional species contains at a minimum two functional SH, OH or COOH groups capable of reacting with the epoxy species.

### TECHNICAL FIELD

The present teachings relate generally to bonding a low surface energy polymer material (e.g., a copolymer, terpolymer or the like) to a substrate. The low surface energy polymer material may be an ethylene vinyl acetate or any other copolymer or terpolymer material, particularly those based upon olefin chemistry. The substrate may also be a polymeric material, which may be a polyurethane material, a natural or synthetic leather, or a natural or synthetic fabric.

### BACKGROUND

Certain challenges exist in adhering materials to low surface energy materials (e.g., materials that have a surface free energy at or below 35 dynes/cm 2). These materials may inherently have low surface energy or may be treated such that they have low surface energy. Specifically, certain low surface energy copolymer or terpolymer materials (which may be a foam and/or an ethylene-based low surface energy materials) commonly utilized in a wide variety of goods including shoes, ski boots, bicycle saddles, hockey pads, boxing gloves and helmets, waterski boots, fishing rods and fishing reel handles, orthotics, surfboard and skimboard traction pads and similar products, present significant challenges to sufficient adhesion. Some of these uses require that the low surface energy copolymer material be adhered to one or more additional materials with significant polarity, surface energy or topography differences. In many cases an organic primer layer is deposited onto the substrates to be bonded together prior to the deposition of an adhesive material. The primer can be an organic solvent-based or a water-based solution, dispersion or suspension. The organic primer layer serves to improve the durability and reliability of the bonded material joint by providing a surface to which the adhesive can more readily adhere and provide a reliable bonded material joint. The primer layer can also serve to broaden the utility of the adhesive, allowing it to be utilized to bond a variety of substrates together.

Following the primer deposition step there are additional process steps that can be required to activate or dry the primer layers. These process steps can include exposure to elevated temperature or to electromagnetic radiation (i.e. an ultraviolet- or infrared-initiated curing step). The additional process steps associated with the handling, application and drying or activation of the primer layer(s) introduce complexity and cost into the manufacturing assembly process. If the primer contains a volatile organic compound (VOC) there can also be worker safety and environmental issues associated with the use of the primer material.

U.S. Pat. No. 5,143,999 describes adhesive compositions including epoxides in combination with dithiols and amines for sealing and injection compositions. However, the use of pre-reacted components for use in combination with additional epoxides or dithiols for adhering to low surface energy materials are not addressed.

In one specific example, low surface energy copolymers are widely used in the fabrication of shoes and it is necessary to bond the low surface energy copolymer to a second material such as a synthetic leather, a polyurethane or a synthetic textile as part of the shoe manufacturing process. To prepare a robust shoe assembly, current state of the art adhesive technology requires that after primer deposition on both substrates as described above, the adhesive be applied to both of the surfaces to be bonded. The deposition of adhesive on both surfaces to be joined creates additional process complexity. It would therefore be desirable to provide an adhesive which can be applied only to one of the surfaces to be joined, preferably the low surface energy copolymer and bonds the low surface energy copolymer to a variety of materials while potentially eliminating the primer layer(s) and its associated manufacturing steps.

### SUMMARY OF THE INVENTION

The present teachings are directed to a method for adhering a low surface energy copolymer (any use of the term copolymer herein encompasses terpolymers as well) and a substrate to bond the low surface energy copolymer and substrate together. This method can include a surface treatment of the low surface energy copolymer with an automated treatment, which could be, but is not limited to, plasma, heat, corona or flame treatment prior to the deposition of the adhesive; mixing a first component with a second component to form the fully formulated adhesive material, applying the adhesive after mixing to the surface of the low surface energy copolymer; and thermally activating the adhesive immediately before contacting with the substrate to adhere the low surface energy copolymer to the substrate. It is possible that the adhesive may be located onto a substrate immediately upon mixing or alternatively waiting while the mixed composition increases in molecular weight before applying to the substrate.

The first and second component of the adhesive composition may each comprise a multitude of ingredients which can in part be selected from one or more of an epoxy, one or more of a dithiol, one or more of a reacted product between an epoxy and a dithiol, one or more reaction catalysts, and optionally one or more amines. The bonding method is preferably free of any step involving the application of a primer to the low surface energy copolymer. After the application of the adhesive components, the low surface energy copolymer may be adhered to the substrate. The assembly time may be typically desired to be minimized. The adhesive composition formed by mixing the two components may be required to develop sufficient adhesive strength to prevent delamination of the bonded assembly either immediately after the assembling process or over a longer period of time. Delamination may be substantially prevented at temperatures ranging from ambient to up to approximately 176° F. The bonding process may occur after the adhesive composition is dispensed on to the low surface energy copolymer (in some cases, an hour or more after the deposition on to the low surface energy copolymer). Advantageously, the adhesive material may also quickly develop dry to the touch characteristics at ambient temperatures prior to assembling, which can be accelerated by thermal conditioning of the dispensed adhesive.

The first component may be an epoxy composition. This epoxy composition can be partially pre-reacted with a di-thiol, an amine, or another functional material, or another molecule which contains predominantly two reactive hydrogens per molecule. The second component may be a mercaptan-based composition with or without reactive amines. This mercaptan composition may be partially pre-reacted with one or more di-functional epoxy resins. The first and the second component may be in the form of a paste or liquid or semi-liquid at ambient temperature.

The low surface energy copolymer surface may be treated, which may be but is not limited to heat treatment, plasma treatment or flame treatment prior to application of the first component, the second component, or some combination thereof.

The viscosity of the first component, the second component or the resulting adhesive may be at least about 10,000 to 400,000 Pa-s under appropriate dispensing conditions. The adhesive may be dispensed onto the low surface energy copolymer before contacting the low surface energy copolymer with the substrate. The low surface energy copolymer may adhere to the substrate without dispensing any adhesive directly onto the substrate. The first component, second component, and adhesive may be substantially free of any volatile organic compounds (VOC's). The first and second component may react upon contact with each other with or without the addition of heat. The bonding method may include applying pressure to adhere the substrate to the low surface energy copolymer. The adhesive may have a viscosity that is sufficiently high so that when applied to the low surface energy copolymer it does not substantially spread out over the substrate from its original dispensed position under normal substrate handling conditions. The method may be free of applying any primer to the low surface energy copolymer or substrate. The low surface energy copolymer may be a mid-sole of a shoe. The substrate may be an upper portion (e.g., strobel) of a shoe. The adhesive may be free of free isocyanates.

### DETAILED DESCRIPTION

The present teachings meet one or more of the above needs by the improved devices and methods described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The teachings herein are directed toward the use of adhesives, which may be 2-part adhesives that are capable of adhering to certain substances that typically present adhering challenges. More specifically, the adhesives herein may be capable of in-situ polymerization on the surface of low surface energy copolymers/terpolymers when a first and second component of the adhesive are combined prior to or concurrently with application to the low surface energy copolymer and/or a substrate for adhering to the low surface energy copolymer.

After the components of the adhesive are applied to the low surface energy copolymer surface, it is possible that prior to assembly, the adhesive polymerization may be advanced by a stimulus which may be a physical stimulus such as heat. It is also possible that the adhesive may polymerize at ambient temperature without the addition of heat prior to adhering to a secondary surface (e.g., the substrate), which may be a second polymeric surface, specific examples of which include polyester-, polyamide-, polyurethane-based or other materials.

It may be desirable that the viscosity of the adhesive (or each of the components of the adhesive) be sufficiently low so that it can be sprayed, dispensed, spread, brushed or otherwise applied to a surface to form a uniform layer, but high enough so that it does not flow beyond an edge of a surface under ambient factory conditions. In some cases, it is useful for the polymerization to advance further so that the adhesive is capable of having sufficient structure so that it resists undesired movement of the adhesive subsequent to assembly.

The first and second components for forming the adhesive may be selected so that the molecular weight of the resulting adhesive is increased but crosslinking of the adhesive is kept to a minimal level. Even minor increases in reactive functionality will generally cause this undesirable degree of crosslinking, particularly if the first and second component's monomers are at or near the stoichiometric ratio.

The adhesive may be described as a reactive two-component adhesive paste which forms a thermoplastic polymer by an in-situ reaction when the two components of the co-reactive composition are mixed and deposited onto a substrate. The in-situ reaction may occur at ambient temperature (˜20-25° C.) and may progress over a period of hours or even days to form the thermoplastic polymer. The polymer, which is formed by the in-situ reaction, may be a thermoplastic (i.e. predominantly linear, capable of softening by exposure to elevated temperature). The reactive monomers which form the thermoplastic polymer may be di-functional, or at least predominantly di-functional.

The adhesive may be a two-component adhesive, including a Part A and a Part B. Part A may contain a thermoplastic prepolymer which is end-capped with unreacted epoxy functionality. Part A may also contain unreacted epoxy resin which is not chemically bound to the thermoplastic prepolymers. Part B of the adhesive composition may contain a low molecular weight thermoplastic prepolymer which is end-capped with unreacted nucleophilic groups which are capable of reaction with epoxy functionality. Part B may also contain unreacted nucleophilic species which are not chemically bound to the prepolymers. Part A and Part B can be mixed and dispensed using conventional approaches (e.g., from separate cartridges or via a dual metering system). The presence of the low molecular weight thermoplastic polymers may improve the green-state (e.g., prior to cure) strength of the adhesive bond.

After dispensing the two components on to one or more of the surfaces to be joined, the adhesive may develop dry to the touch characteristics at ambient temperature (approximately 20° C.). It is possible that the development of dry to the touch characteristics can be accelerated by brief exposure to elevated temperature. Once the components are dispensed onto a first surface, the adhesive may remain on the substrate in a dry state until a later time (e.g., the applied adhesive may have an extended shelf life) when it is contacted with a second surface for forming the adhesive joint. Prior to contact with the second surface to be joined, the adhesive may be activated (e.g., possibly by an external stimulus) to increase the adhesive to a temperature where it develops adhesion and/or cures. Once the bonded joint has been formed, the adhesive continues to react at ambient (or greater) temperature to form a high molecular weight thermoplastic polymer. The adhesive may remain a thermoplastic or alternatively may begin as a thermoplastic but eventually become a thermoset material.

One or more components of the adhesive may comprise a reactive epoxy such as a chemically modified liquid diglycidyl ether of bisphenol A. One or more components may include a particulate material that may modify a physical characteristic of the adhesive material. Such particulates may be for example, a fumed silica or modified phyllosilicate. One or more components of the adhesive may comprise a monofunctional primary amine, for example a monoethanolamine, a furfurylamine, an octylamine or an octadecylamine. One or more of the components of the adhesive may comprise an odor masking agent that may be, but is not limited to, a zinc ricinoleate. One or more of the components of the adhesive may comprise a mercaptan or dithiol which may be but is not limited to a glycol-di(3-mercaptopropionate), a 1,8-dimercapto-3,6-dioxaoctane or another thioether. One or more of the components may also comprise a mercaptan-epoxy reaction catalyst, such as benzyldimethylamine, 2,4,6-tris(dimethylaminomethyl)phenol, or triphenylphosphine. One or more of the components may include a secondary diamine.

One or more of the components may comprise a functionalized compound that can be, but which is not restricted to a functionalized liquid elastomer or a functionalized polyether. Functional groups could be carboxyl (000H), thiol (SH) or amine (NH or NH2). The number of functional groups per molecule is preferably up to two, and the number active hydrogens per molecule that are capable of reaction with the epoxy functionality is preferably two or more. This ingredient can be a butadiene homopolymer or butadiene-acrylonitrile copolymer with functionality at the chains ends. This ingredient can be also an ethoxylated-trimethylolpropane tris(3-mercaptopropionate).

One or more of the components of the adhesive may be comprised of a pre-reaction product between two or more of the ingredients described herein.

The components and/or the resulting adhesive may be applied to a low surface energy copolymer substrate in a format that is liquid-like yet with a viscosity high enough to remain on the surface without significant flow. Alternatively, the components and/or the resulting adhesive may be located onto a surface in a paste-like format. The resulting adhesive may be a thermoplastic material (see Table, 1 Example 1), but may also be a thermoset material (see Table 1, Examples 2 and 3). It may be a thermoplastic material that forms a thermoset after deposition, for example, one day or more after deposition. Upon adhering the low surface energy copolymer to a desired substrate, the adhesive may be sufficiently flexible and strong so that upon movement and flexing of the low surface energy copolymer material and substrate, the adhesive does not break. The adhesive components may be storage stable for at least one month, at least three months, or even at least six months at ambient temperature.

It is possible that the one or more components for forming the adhesive may include a di-primary amine, for example amine terminated butadiene acrylonitrile copolymer (ATBN) in combination with one or more mercaptans. One or more components may include a tertiary amine. It is possible that upon mixing Part A and Part B, an initial fast reaction occurs and creates a thermoplastic material, and a second slower reaction creates a thermoset material. Generally, a mercaptan and epoxy reaction is very rapid and thus may not require a large mass of material to create a sufficient exotherm to produce a rapid reaction. Thus, in combination with the amine terminated butadiene acrylonitrile copolymer, the ATBN behaves primarily like a latent curing agent over a lengthy time to form a thermoset material. The ATBN in this case would have more than two reactive hydrogens. It is possible that a tertiary amine is crosslinking the adhesive through homopolymerization of residual epoxy. This reaction may occur at ambient temperature and is slower than the epoxy/thiol reaction to promote an optimum thermoplastic phase for assembly.

The thermoplastic prepolymer contained in part A of the two-component adhesive may be prepared by reacting a dinucleophile with a stoichiometric excess of an epoxy resin to create a polymer which is end-capped with unreacted epoxy functionality. A portion of the epoxy may be optionally blended or compounded with a catalyst and heated to an elevated temperature. The dinucleophile may be optionally blended or compounded with a catalyst and mixed with the epoxy, either in a continuous fashion or in increments. Once the Part A prepolymer is prepared, additional epoxy may be added along with silica and additional ingredients to form the fully formulated Part A.

The thermoplastic prepolymer contained in Part B of the two-component adhesive may be prepared by reacting a diepoxy with a stoichiometric excess of a dinucleophile to create a polymer which is end-capped with unreacted nucleophile functionality. A portion of the dinucleophile along with an optional catalyst may be heated to elevated temperature. The epoxy may then be mixed in, either in a continuous fashion or in increments. Once the Part B prepolymer is prepared, additional dinucleophile may be added along with additional ingredients to form the fully formulated Part B.

The di-functional epoxy can be for example an epoxy based on bisphenol A or bisphenol F. For example, the dinucleophile can be a dithiol, a bisphenol, a dicarboxylic acid, a difunctional sulfonamide or a diamine.

The optional catalyst discussed herein may be utilized to promote the epoxy-nucleophile reaction. Additional catalyst can be added once the reaction which forms the low molecular weight thermoplastic polymer is substantially complete. When Parts A and B are mixed and deposited onto a substrate, reaction between the epoxy and the nucleophilic groups will commence. The use of a basic catalyst may be desirable or may be required to control the reaction rate of the epoxy and nucleophile in the preparation of the thermoplastic prepolymers and the in-situ polymerization step. The reaction may continue once the bonded joint has been formed at ambient or elevated temperature, allowing full development of adhesive properties. The final polymer, once “in-situ” polymerization in the bonded joint is complete, may be substantially linear and thermoplastic in nature. The composition may develop “dry to the touch” characteristics at ambient temperatures prior to bonding, even though all the epoxy and nucleophile groups have not yet been fully consumed by reaction.

The partially reacted adhesive can be activated by thermal exposure, radiation, or another external stimulus prior to placing the two surfaces to be bonded in contact with one another.

One or more components of the adhesive may comprise one or more epoxy materials which may be bisphenol A diglycidyl ether, a bisphenol F diglycidyl ether or aliphatic or cycloaliphatic-based epoxies. Predominantly di-functional epoxies may be selected as monofunctional materials may limit the ability to obtain sufficiently high molecular weight. On the other hand, tri or tetra functionality in sufficient quantities may lead to early undesirable gelling. One, or both, of the components of the adhesive may contain a pre-formed low molecular weight, reactive, substantially linear, reactive pre-polymer in addition to either the diepoxy or dinucleophile. The reactive pre-polymer may be the reaction product of a diepoxy and a dinucleophile, prepared with either a diepoxy or a dinucleophile stoichiometric excess. The stoichiometric ratio determines whether the pre-polymer is terminated with unreacted epoxy or nucleophilic functionality. The reactive end group functionality determines into which side of the adhesive the reactive pre-polymer is placed.

The adhesive may also include one or more reinforcement components. Preferably the reinforcement components include a material that is generally non-reactive with the other components present in the adhesive. It is contemplated that the reinforcement components may act as a rheology modifier.

Examples of reinforcement components include wollastonite, silica, diatomaceous earth, glass, clay (e.g., including nanoclay), glass beads or bubbles, glass, carbon or ceramic fibers, nylon, aramid or polyamide fibers, and the like. The one or more reinforcement components may be selected from pyrophyllite, sauconite, saponite, nontronite, or montmorillonite. The reinforcement component may include a calcium mineral reinforcement. The reinforcement component may include glass, glass beads or bubbles, carbon or ceramic fibers, nylon, aramid or polyamide fibers (e.g., Kevlar). The adhesive may further include one or more fillers including pigments or colorants, calcium carbonate, talc, silicate minerals, vermiculite, mica, or the like.

When employed, the reinforcement components in the adhesive can range from 0.05% or less to 90% or greater by weight of the adhesive, but more typically from about 0.5% to 10% by weight of the adhesive. According to some embodiments, the adhesive may include from about 0% to about 30% by weight, and more preferably slightly less than 10% by weight reinforcement components.

The adhesive may be formulated to include an elastomeric component. The elastomeric component may be included in an amount of up to about 75% by weight of the adhesive. The elastomeric component may be approximately at least about 1% by weight, more typically at least about 5% by weight, more typically at least about 10% by weight, and even more typically at least about 15% by weight of the adhesive. The elastomeric component may be solid, liquid, or semisolids at a temperature of 23° C. or may also be some combination thereof.

The elastomeric component may be a thermosetting liquid or solid elastomer, although not required. Exemplary elastomers include, without limitation, natural rubber, styrene-butadiene rubber, polyisoprene, polyisobutylene, diene, isoprene-butadiene copolymer, neoprene, nitrile rubber (e.g., a butyl nitrile, such as carboxy-terminated butyl nitrile), butyl rubber, polysulfide elastomer, acrylic elastomer, acrylonitrile elastomers, silicone rubber, polysiloxanes, polyester rubber, diisocyanate-linked condensation elastomer, EPDM (ethylene-propylene diene rubbers), chlorosulphonated polyethylene, fluorinated hydrocarbons and the like. Carboxyl-terminated butadiene-acrylonitrile (CTBN) may be particularly useful for developing adhesion.

The adhesive may include at least one type of polymeric particle. As used herein, like with any other ingredients of the present teachings, the term “polymeric particle” can include one or more types of polymeric particles. It is generally preferable for the polymeric particles to be at least 0.5%, more typically at least 2%, even more typically at least 5%, still more typically at least 7% and even still more typically at least 10% by weight of the adhesive and also preferable for the polymeric particle to be less than 90%, more typically less than 40% an even more typically less than 30% by weight of the adhesive, although higher or lower amounts may be used in particular embodiments. The one or more types of polymeric particle may include one or any combination of a toughening particle, a flexibilizing particle, a viscosity modifying particle or some combination thereof. The polymeric particle may include a core shell material.

One or more curing agents may be added to the adhesive. Amounts of curing agents can vary widely within the adhesive depending upon the desired structural properties of the adhesive. Exemplary ranges for the curing agents in the adhesive range from about 0.001% by weight to about 7% by weight.

It is possible that the curing agents assist the adhesive in curing by crosslinking of the polymers, epoxy resins or both. It is also possible for the curing agents to assist in advancing or chain extending the adhesive. Useful classes of curing agents are materials selected from aliphatic or aromatic amines or their respective adducts, amidoamines, polyamides, cycloaliphatic amines, anhydrides, polycarboxylic polyesters, isocyanates, phenol-based resins (e.g., phenol or cresol novolak resins, copolymers such as those of phenol terpene, polyvinyl phenol, or bisphenol-A formaldehyde copolymers, bishydroxyphenyl alkanes or the like), or mixtures thereof. Particular preferred curing agents include modified and unmodified polyamines or polyamides such as triethylenetetramine and/or diethylenetriamine tetraethylenepentamine.

Adhering the low surface energy copolymer to the substrate may occur in the absence of any step of priming the low surface energy copolymer or substrate. It may occur in the absence of any UV light treatment. It may occur without any initial steps of washing the low surface energy copolymer or washing the substrate. The adhesive may adhere upon contact between the low surface energy copolymer and the substrate. The adhesive may allow the low surface energy copolymer to contact the substrate initially and then be adjusted to ideal fit without disrupting the bonding performance of the adhesive. The components and/or adhesive may be applied to the low surface energy copolymer and then subsequently thermally activated, or even thermally re-activated prior to assembly. The adhesion between the low surface energy copolymer and the substrate may be sufficient so that the low surface energy copolymer tears prior to failure of the adhesive at the surface of the-substrate.

The surface upon which the adhesive components are located may be a low surface energy copolymer material. The surface itself may be pretreated prior to the application of any adhesive components. The surface may be heat treated to modify the surface of the low surface energy copolymer. The surface may be plasma treated, corona treated, flame treated, or treated in some way to increase the surface energy of the low surface energy copolymer. The treatment may be free of any primer application.

The low surface energy copolymer may be injection molded, which typically requires use of a mold release formulation. This mold release formulation may or may not be washed from both the mold and the resulting low surface energy copolymer. Adhesion to the low surface energy copolymer may include infiltration of a porous substrate to encapsulate a portion of a porous surface and develop a mechanical bond/interlock. One or more of the components utilized for adhering may comprise an epoxy system with two or more epoxy groups per molecule. One or more of the components may comprise a reaction initiator having two reactive hydrogen. When these molecules interact the chain extension occurs and result into the creation of a polymer. This polymeric structure develops bonding properties either with treated low surface energy copolymer surfaces and various substrates. The cohesive strength of the polymeric structure may be partially or totally a function of the polymerization advancement. Depending upon the substrate to which the low surface energy copolymer adheres, it may be necessary to reach a certain level of reaction advancement prior to assembly. A certain quantity of reactant and epoxy may be pre-reacted during the adhesive manufacturing process to form a polymer or a pre-polymer. This polymer can be used as an ingredient in one or more of the components of the adhesive as shown in Table 1.

TABLE 1

| | Example 1 | | Example 2 | | | Example 3 | | | |
|---|---|---|---|---|---|---|---|---|---|
| | Part A | Part B | Part A | | Part B | Part A | | Part B | |
| Part A:Part B ratio, | 66 | 34 | 80 | | 20 | 50 | | 50 | |
| by weight | | | | | | | | | |
| High purity | 97.65 | | 51.75 | | | 30.51 | | 43.95 | |
| Diglycidyl Ether of | | | | | | | | | |
| Bisphenol A | | | | | | | | | |
| (DGEBA) | | | | | | | | | |
| Modified liquid | | | 8.47 | 8.47 | | 51.8 | 51.8 | | |
| DGEBA | | | | | | | | | |
| Solid DEGBA | | | 12.45 | 12.45 | | | | | |
| Dithiol | | 90.13 | 24.54 | | | 15.78 | | 43.39 | 20.28 |
| Tertiary amine | | 5.3 | 0.2 | | | 0.14 | | 0.38 | |
| Pre-reacted | | | | 76.49 | | | 46.43 | | 67.44 |
| product: | | | | | | | | | |
| High purity liquid | | | | | | | | | |
| DGEBA/Di- | | | | | | | | | |
| thiol/Tertiary amine | | | | | | | | | |
| Amine terminated | | | | | 100 | | | 8.76 | 8.76 |
| liquid | | | | | | | | | |
| polybutadiene | | | | | | | | | |
| acrylonitrile rubber | | | | | | | | | |
| Fumed silica | 2.35 | 4.57 | 2.59 | 2.59 | | 1.77 | 1.77 | 1.77 | 1.77 |
| Zinc ricinoleate | | | | | | | | 1.75 | 1.75 |
| (odor masquant) | | | | | | | | | |
| Total | 100 | 100 | 100 | 100 | 100 | 100 | 100 | 100 | 100 |
| Viscosity ASTM | 6,000 at | 200 at | 400,000 at | | 100,000 at | 14,000 at 80° C. | | 53,000 at 80° C. | |
| D-445 (mPa · s) | 25° C. | 25° C. | 70° C. | | 25° C. | 6,400 at 90° C. | | 30,000 at 90° C. | |
| Resistance to | Some debonding | | Some debonding | | | Optimum, no debonding | | | |
| immediate pulling | | | | | | | | | |
| effect at ambient | | | | | | | | | |
| temperature after | | | | | | | | | |
| shoe assembly | | | | | | | | | |
| Automated | Spray/static mixer | | Non applicable | | | Static mixer nozzle | | | |
| dispensing | nozzle | | | | | | | | |
| capability | | | | | | | | | |
| Reaction | 30 h at 25° C. | | Not required | | | 20 mins at 70° C. | | | |
| advancement, | | | | | | 30 mins at 60° C. | | | |
| 0.3 mm thick | | | | | | | | | |
| Peel strength Low | >3 Kg/cm EVA failure | | >3 Kg/cm EVA failure | | | >3 Kg/cm EVA failure | | | |
| surface energy | | | | | | | | | |
| copolymer/polyester | | | | | | | | | |
| mesh (Kg/cm) | | | | | | | | | |
| 30 mins Dead load | Fail-Cohesive failure | | Pass-Substrate failure (EVA) | | | Pass-Substrate failure (EVA) | | | |
| test 80° C.- | | | | | | | | | |
| 1 Kg/25 mm | | | | | | | | | |
| width/Low surface | | | | | | | | | |
| energy copolymer | | | | | | | | | |
| polyester mesh | | | | | | | | | |

Table II below describes non-limiting reaction products for Part A and Part B.

TABLE II

| | Part A | | Part B | |
|---|---|---|---|---|
| Part A:Part B ratio, by weight | 50 | | 50 | |
| High purity Diglycidyl Ether of | 80.97 | 41.91 | 46.95 | |
| Bisphenol A (DGEBA) | | | | |
| Modified liquid DGEBA | | | | |
| Solid DGEBA | | | | |
| Dithiol | 17.12 | | 49.18 | 19.67 |
| Tertiary amine | 0.14 | | 2.09 | |
| Pre-reacted product: | | 56.18 | | 76.46 |
| High purity liquid DGEBA/ | | | | |
| Di-thiol/Tertiary amine | | | | |
| Amine terminated liquid | | 0.14 | | 2.09 |
| polybutadiene | | | | |
| acrylonitrile rubber | | | | |
| Fumed silica | 1.77 | 1.77 | 1.80 | 1.80 |
| Total | 100 | 100 | 100 | 100 |

| | | |
|---|---|---|
| Viscosity ASTM D-445 (mPa · s) | 60,000 at 60° C. | 60,000 at 60° C. |

| | |
|---|---|
| Resistance to immediate pulling | Some slight debonding |
| effect at ambient temperature | |
| after shoe assembly | |
| Automated dispensing capability | Static mixer nozzle |
| Reaction advancement, | 14 min at room temperature |
| 0.3 mm thick | |
| Peel strength Low surface energy | >3 Kg/cm EVA failure |
| copolymer/polyester mesh (Kg/cm) | |
| 30 mins Dead load test 80° C.-1 | Pass- debonding < 12.5 mm |
| Kg/25 mm width/polyester mesh | |

As used herein, unless otherwise stated, the teachings envision that any substrate of a genus (list) may be excluded from the genus; and/or any substrate of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of “at least ‘x’ parts by weight of the resulting composition” also contemplates a teaching of ranges of same recited amount of “x” in percent by weight of the resulting composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for ail purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A two-part adhesive composition comprising:
a part A including one or more of:
i) an epoxy having at least two epoxy groups per molecule; and/or
ii) a reaction product of an epoxy and a thiol, phenolic or carboxylic acid-functional species;
a part B comprising a reaction product of an epoxy and a thiol, phenolic or carboxylic acid-functional species, wherein the thiol, amine, phenolic or carboxylic acid-functional species contains at a minimum two functional SH, OH or COOH groups capable of reacting with the epoxy species.

2. The adhesive composition of claim 1, including an excess of tertiary amine for crosslinking the adhesive.

3. The adhesive composition of claim 1, including a flexibilizing agent.

4. The adhesive composition of claim 3, wherein the flexibilizing agent is an amine terminated liquid polybutadiene acrylonitrile rubber.

5. The adhesive composition of claim 2, including a catalyst for producing the part A and/or part B.

6. The adhesive composition of claim 1, including a particulate modifying material selected from silica, clay, calcium carbonate, mica, other silicates, or combinations thereof.

7. The adhesive composition of claim 1, including a scent masking agent.

8. The adhesive composition of claim 7, wherein the scent masking agent also acts as an adhesion promotor.

9. The adhesive composition of claim 1, wherein the thiol, phenolic or carboxylic acid-functional species of part A includes at a minimum two active hydrogen groups capable of reacting with an epoxy species.

10. The adhesive composition of claim 3, wherein the adhesive achieves sufficient bonding without the use of an organic polymer primer layer.

11. The adhesive composition of claim 1, wherein the adhesive is adapted for deposition on only one surface of two members to be joined together.

12. The adhesive composition of claim 1, including a crosslinker that is a functionalized multifunctional elastomer.

13. The adhesive composition of claim 10, wherein the components of part A and part B are selected to form an adhesive having a relatively high molecular weight.

14. The adhesive composition of claim 1, wherein the components of part A and part B are selected to form an adhesive that is initially a thermoplastic material and becomes a thermoset material over time.

15. A two-part adhesive composition comprising:
a part A including one or more of:
i) an epoxy having at least two epoxy groups per molecule; and/or
ii) a reaction product of a di functional epoxy and a di-thiol, di-phenolic or dicarboxylic acid-functional species;
a part B including one or more of:
i) a thiol having at least two thiol groups per molecule; and/or
ii) a reaction product of an epoxy and a thiol, phenolic or carboxylic acid-functional species, wherein the thiol, amine, phenolic or carboxylic acid-functional species contains at a minimum two functional SH, OH or COOH groups capable of reacting with the epoxy species.

16. The adhesive composition of claim 15, including a catalyst in part A and/or part B.

17. The adhesive composition of claim 15, including an excess of tertiary amine for crosslinking the adhesive.

18. A method for adhering a substrate to a low surface energy polymer, comprising:
optionally treating the low surface energy polymer surface either physically or chemically to modify its the surface energy;
applying an adhesive formulated with one or more epoxy materials, a dithiol and a mercaptan-epoxy catalyst.

19. The method of claim 18, wherein no primer is applied onto the low surface energy polymer surface or the substrate.

20-21. (canceled)

22. The method of claim 18, wherein the adhesive is a 2-component material.

23-31. (canceled)
